(19) United States
(12) Patent Application Publication
(10) Pub. No.: US 2014/0325475 A1
(43) Pub. Date: Oct. 30, 2014

(54) REFERENCING AND SYNCHRONIZATION OF EMAIL THREADS INTO INTEGRATED DEVELOPMENT ENVIRONMENT (IDE)

(71) Applicant: INTERNATIONAL BUSINESS MACHINES CORPORATION, Armonk, NY (US)

(72) Inventors: Kulvir Singh Bhogal, Austin, TX (US); Lisa Seacat DeLuca, San Francisco, CA (US); Robert Ross Peterson, Austin, TX (US)

(73) Assignee: International Business Machines Corporation, Armonk, NY (US)

(21) Appl. No.: 13/870,585

(22) Filed: Apr. 25, 2013

(51) Int. Cl. G06F 9/44

(52) U.S. Cl. CPC G06F 8/34
USPC 717/109

(57) ABSTRACT

A method includes providing a source control system in an integrated development environment, providing an email server through which the integrated development environment can communicate, providing an email mapping reference repository, and using the email mapping reference repository to find a linked email from the email server and provide the linked email to the integrated development environment.

### BACKGROUND

The present invention relates to providing email within the integrated development environment (IDE), and more specifically, to provide linked email threads within the IDE.

### SUMMARY

According to one aspect of the present invention, a method includes providing a source control system in an integrated development environment; providing an email server through which the integrated development environment can communicate; providing an email mapping reference repository; and using the email mapping reference repository to find a linked email from the email server and provide the linked email to the integrated development environment.

According to another aspect of the present invention, a computer system includes one or more processors, one or more computer-readable memories and one or more computer-readable, tangible storage devices; a source control system operatively coupled to at least one of the one or more storage devices for execution by at least one of the one or more processors via at least one of the one or more memories, configured to provide information in an integrated development environment; an email server operatively coupled to at least one of the one or more storage devices for execution by at least one of the one or more processors via at least one of the one or more memories, configured to provide email communications in the integrated development environment; and an email mapping reference repository operatively coupled to at least one of the one or more storage devices for execution by at least one of the one or more processors via at least one of the one or more memories, configured to find a linked email in the email server and provide the linked email to the integrated development environment.

According to still another aspect of the present invention, a computer program product includes one or more computer-readable, tangible storage medium; program instructions, stored on at least one of the one or more storage medium, to access a source control system in an integrated development environment; program instructions, stored on at least one of the one or more storage medium, to access an email server through which the integrated development environment can communicate; program instructions, stored on at least one of the one or more storage medium, to access an email mapping reference repository; and program instructions, stored on at least one of the one or more storage medium, causing the email mapping reference repository to find a linked email in the email server and provide the linked email to the integrated development environment.

### BRIEF DESCRIPTION OF THE SEVERAL VIEWS OF THE DRAWINGS

FIG. 1 illustrates a connectivity diagram for ecosystem according to an embodiment of the present invention.

FIG. 2 depicts a mapping table according to an embodiment of the present invention.

FIG. 3 depicts an exemplary implementation according to an embodiment of the present invention.

FIG. 4 shows a flowchart according to an embodiment of the present invention.

FIG. 5 illustrates a hardware configuration according to an embodiment of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. As will be appreciated by one skilled in the art, aspects of the present invention may be embodied as a system, method or computer program product.

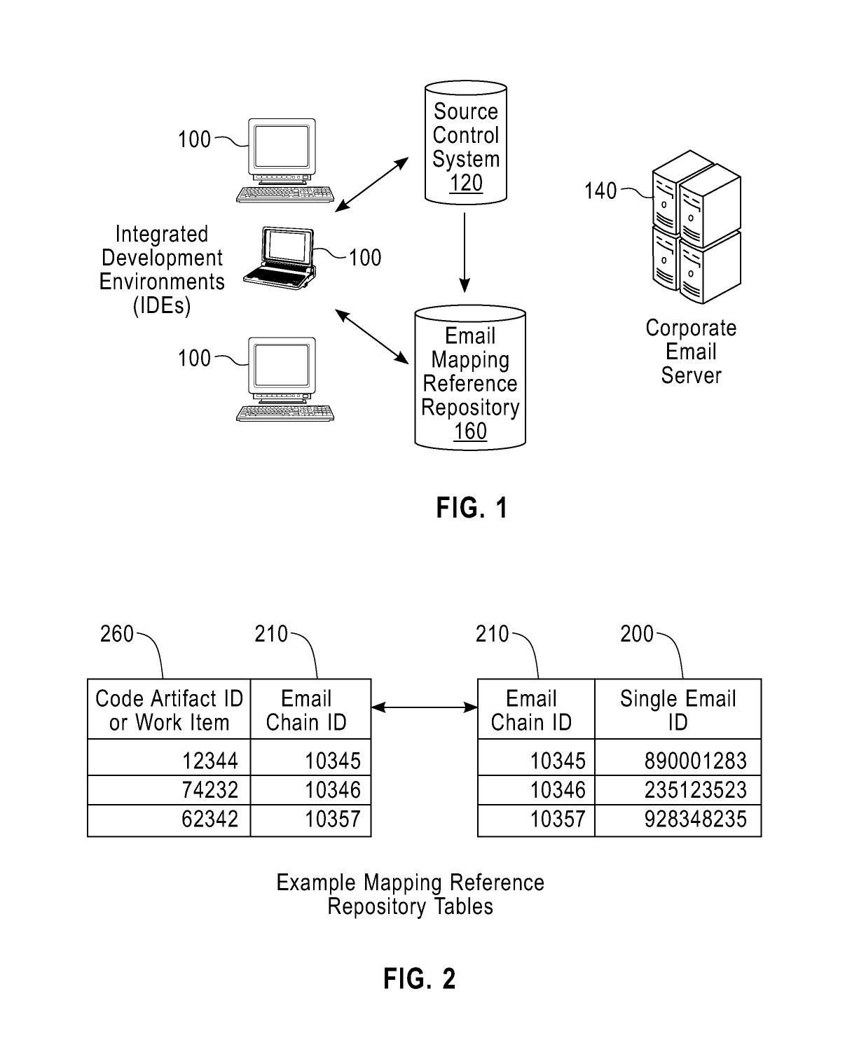

With reference now to FIGS. 1 and 2, an ecosystem according to an embodiment of the present invention is shown. Development lifecycle tools such as RTC, Jazz, and ClearCase are continually being integrated. They are also progressively fading the line between integrated development environments (IDEs) and the server. Integrating an email server into this ecosystem is natural progression. IDEs/Defect Tools 100 are operationally connected to a source control system [or defect repositories which are not shown in the diagram] 120. The IDEs are further operationally connected to a corporate email server 140. The addition element of this ecosystem is an email mapping reference repository 160. The email mapping reference repository 160 is operationally connected to IDEs 100, the source control system 120 and the corporate email sever 140. In one embodiment of the present invention, the email mapping reference repository 160 would map code artifacts (or defects) or work items to emails or entire chains. The email mapping reference repository 160 would not store emails or code, but would only reference them and provide the IDEs 100 the linked email. Example schema/tables are shown in FIG. 2. Both tables have composite primary keys and Email Chain ID 210 is a shared/foreign column. The table on the right lists the single email ID 200 for each email and the email chain ID 210. The email mapping reference repository 160 then maps the table on the right with the table on the left. The table on the left lists not only the email chain ID 210, but the code artifact ID (defect ID) or work item ID 260 as well. This mapped information is provide to the IDEs 100. It is noted a code artifact might be the name of a code file, a method name, a variable name, etc. It is further noted a work item could be a task, defect, story, epic, feature, etc. Both the code artifact and the work item can serve as a linking item for the email.

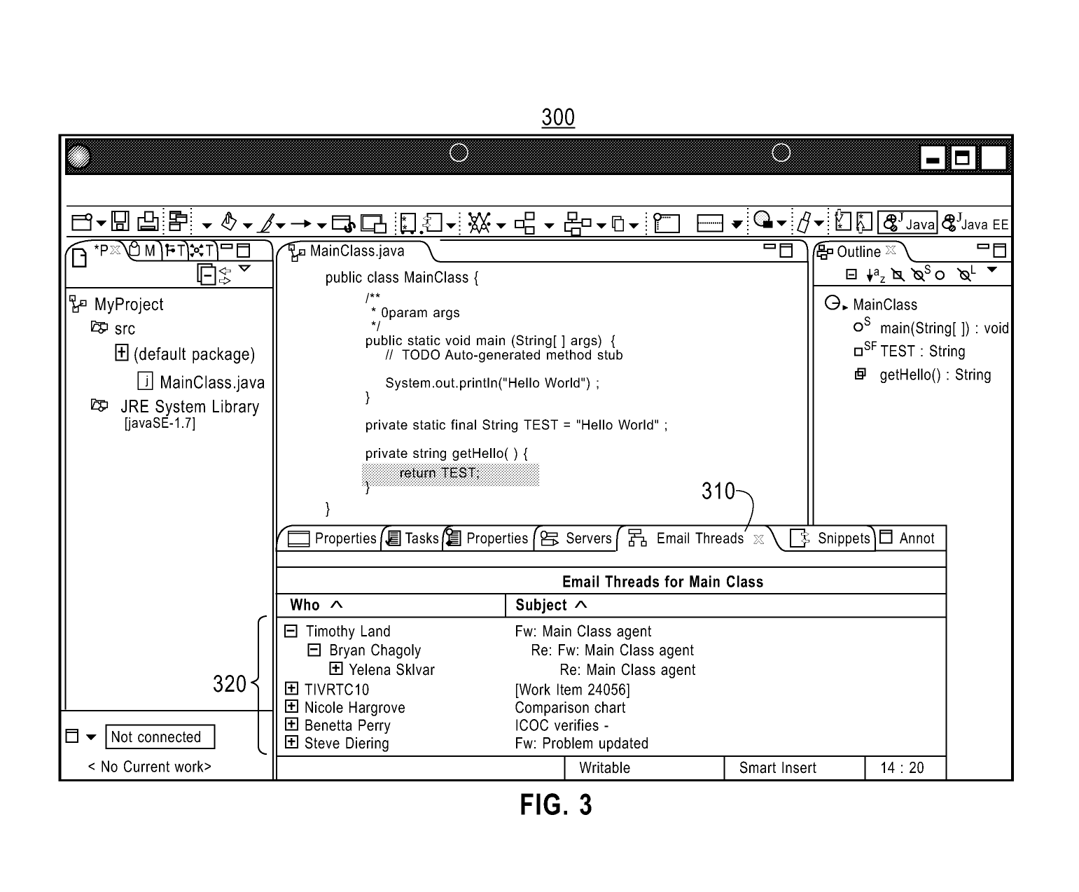

Referring to FIG. 3, shown is exemplary implementations according to an embodiment of the present invention. Within the IDE program 300, a user is presented with an email thread tab 310. As mentioned, the ecosystem according to an embodiment of the present invention allows developers to see email chains associated with code artifacts such as classes, packages, methods, and data structures directly in their Integrated Development Environment (IDE). Email thread tab 310 shows the javascript pseudo package “mainclass” is associated with emails shown in the email threads tab 310. Should the user open a different file or selection other code snippets, the email thread view changes to the email chains associated with that context (if any).

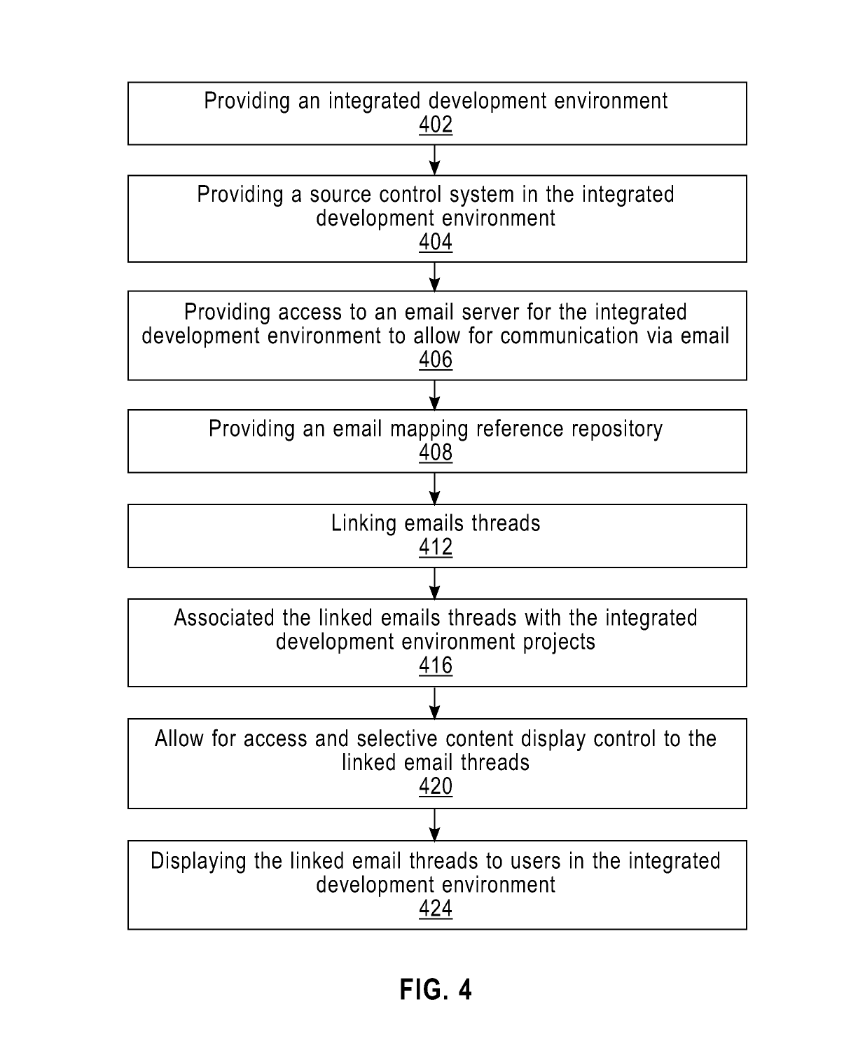

Referring to FIG. 4, a flowchart for an embodiment of the present invention is shown. The process starts by providing an integrated development environment (400). The process continues by adding a source control repository in the integrated development environment (404). Further included as part of the process, is provide access to an email server for the integrated development environment to allow for communication via email (406). An email mapping reference repository is provided (408). The process continues by linking email threads (412) and associate the linked email threads with the integrated development environment projects (416). The process allows for access control to the linked email threads (420) before displaying the linked email threads to users in the integrated development environment (424).

Still referring to FIG. 4, access control addresses any privacy issue that may need to be addressed. Team members sending and being copied on a particular email may not want anyone to be able to see the email in an IDE or defect tool. One approach to alleviate this is to restrict an email chain (or sub-emails) to only the parties that were originally on the email FROM, TO, CC, and BCC fields. By default this can be overridden by anyone on the email as well—a request is made through the tool to a member on the email by the person that wants access. Emails that a user does not have viewing privileges for may be grayed out in the tool. An additional privacy solution can be provided for selective content display control. A user might receive a prompt within their email client asking if they are willing to share a particular message that is associated with a defect. The user may choose, yes, no, or partial. If they choose to partially share the message they can pick and choose amongst the email content what to share. This would allow users to strip out information such as signatures or information not related to the defect. After they have finished marking the shareable section they can choose “share” to place the link within the IDE defect tracking area.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

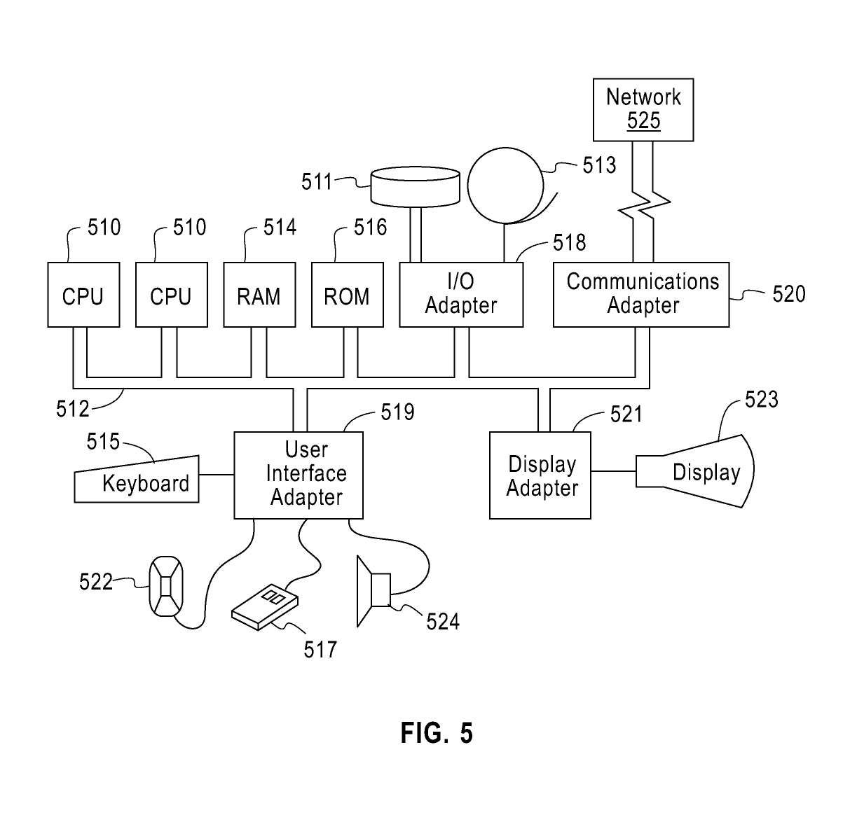

Referring now to FIG. 5, this schematic drawing illustrates a hardware configuration of an information handling/computer system in accordance with the embodiments of the invention. The system comprises at least one processor or central processing unit (CPU) 510. The CPUs 510 are interconnected via system bus 512 to various devices such as a random access memory (RAM) 514, read-only memory (ROM) 516, and an input/output (I/O) adapter 518. The I/O adapter 518 can connect to peripheral devices, such as disk units 511 and tape drives 513, or other program storage devices that are readable by the system. The system can read the inventive instructions on the program storage devices and follow these instructions to execute the methodology of the embodiments of the invention. The system further includes a user interface adapter 519 that connects a keyboard 515, mouse 517, speaker 524, microphone 522, and/or other user interface devices such as a touch screen device (not shown) to the bus 512 to gather user input. Additionally, a communication adapter 520 connects the bus 512 to a data processing network 525, and a display adapter 521 connects the bus 512 to a display device 523 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
providing a source control system in an integrated development environment;
providing an email server through which the integrated development environment can communicate;
providing an email mapping reference repository; and
using the email mapping reference repository to find a linked email from the email server and provide the linked email to the integrated development environment.

2. The method according to claim 1, wherein the linked email references at least one of a code artifact and a work item.

3. The method according to claim 1, further comprises displaying the linked email to users in the integrated development environment.

4. The method according to claim 1, further comprises providing access control to the linked email.

5. The method according to claim 1, wherein the linked email references at least one code artifact ID and a work item associated with email ID.

6. The method according to claim 4, wherein recipient fields of the linked email provide the access control.

7. The method according to claim 4, further comprises providing selective content display control to the linked email.

8. The method according to claim 7, wherein recipients receiving the linked email provide the selective content display control.

9. A computer system comprising:
one or more processors, one or more computer-readable memories and one or more computer-readable, tangible storage devices;
a source control system operatively coupled to at least one of the one or more storage devices for execution by at least one of the one or more processors via at least one of the one or more memories, configured to provide information in an integrated development environment;
an email server operatively coupled to at least one of the one or more storage devices for execution by at least one of the one or more processors via at least one of the one or more memories, configured to provide email communications in the integrated development environment; and
an email mapping reference repository operatively coupled to at least one of the one or more storage devices for execution by at least one of the one or more processors via at least one of the one or more memories, configured to find a linked email in the email server and provide the linked email to the integrated development environment.

10. The system according to claim 9, wherein the linked email references at least one of a code artifact and a work item.

11. The system according to claim 9, further includes an integrated development environment module operatively coupled to at least one of the one or more storage devices for execution by at least one of the one or more processors via at least one of the one or more memories, configured to display the linked email to users.

12. The system according to claim 9, further includes an access control module operatively coupled to at least one of the one or more storage devices for execution by at least one of the one or more processors via at least one of the one or more memories, configured to provide access control to the linked email.

13. The system according to claim 9, wherein the linked email references at least one code artifact ID and a work item associated with an email ID.

14. The system according to claim 12, wherein recipient fields of the linked email provide the access control.

15. The system according to claim 13, further includes a selective content display control module operatively coupled to at least one of the one or more storage devices for execution by at least one of the one or more processors via at least one of the one or more memories, configured to provide selective content display control to the linked email.

16. The system according to claim 15, wherein recipients receiving the linked email provide the selective content display control.

17. A computer program product comprising:
one or more computer-readable, tangible storage medium;
program instructions, stored on at least one of the one or more storage medium, to access a source control system in an integrated development environment;
program instructions, stored on at least one of the one or more storage medium, to access an email server through which the integrated development environment can communicate;
program instructions, stored on at least one of the one or more storage medium, to access an email mapping reference repository; and
program instructions, stored on at least one of the one or more storage medium, causing the email mapping reference repository to find a linked email in the email server and provide the linked email to the integrated development environment.

18. The computer program product according to claim 17, wherein the linked email references at least one of a code artifact and a work item.

19. The computer program product according to claim 17, further includes program instructions, stored on at least one of the one or more storage medium, for causing the display of the linked email to users in the integrated development environment.

20. The computer program product according to claim 17, further includes program instructions, stored on at least one of the one or more storage medium, for providing access control to the linked email.

21. The computer program product according to claim 17, wherein the linked emails threads references at least one code artifact ID and a work item associated with an email ID.

22. The computer program product according to claim 20, wherein recipient fields of the linked email provide the access control.

23. The computer program product according to claim 21, further includes program instructions, stored on at least one of the one or more storage medium, to cause selective content display control to the linked email.

24. The computer program product according to claim 23, wherein recipients receiving the linked email provide the selective content display control.
